(19) United States
(12) Patent Application Publication
(10) Pub. No.: US 2019/0122485 A1
(43) Pub. Date: Apr. 25, 2019

(54) GAMING DEVICE HAVING A MASTER SYMBOL AND RADIALLY EXPANDING MATRIX AND METHOD OF OPERATING SUCH

(71) Applicant: High 5 Games, LLC, New York, NY (US)

(72) Inventors: Anthony Singer, Jersey City, NJ (US); Micheal Rothenberg, Fair Lawn, NJ (US); Brent Daniels, Brooklyn, NY (US)

(73) Assignee: High 5 Games, LLC, Nnew York, NY (US)

(21) Appl. No.: 16/127,156

(22) Filed: Sep. 10, 2018

Related U.S. Application Data
(60) Provisional application No. 62/555,881, filed on Sep. 8, 2017.

(51) Int. Cl. G07F 17/32

(52) U.S. Cl. CPC G07F 17/3213; G07F 17/34; G07F 17/3244; G07F 17/3209

(57) ABSTRACT

A game device comprising: a display device; an input device; a plurality of symbols; plurality of reels, each reel comprising a plurality of reel symbol positions wherein there is a symbol from the plurality of symbols in each reel symbol position; and a processor for accessing a plurality of instructions which, when executed by the processor, cause the processor to operate with the display device and the input device to: display a symbol matrix comprising a plurality of symbol matrix positions including a master symbol position; display one of the symbols in the master symbol position; generate a plurality of random numbers using a random number generator; display a portion of a plurality of first reels from the plurality of reels in the symbol matrix positions; determine if any of the symbols displayed in the symbol matrix match the first matching symbol.

### CROSS-REFERENCE TO RELATED APPLICATIONS

This application claims priority to U.S. Provisional Patent Application Ser. No. 62/555,881 filed Sep. 8, 2017 and titled “GAMING MACHINE AND METHOD OF OPERATING A GAMING MACHINE”.

### BACKGROUND

### Field of Invention

Embodiments of the present invention generally relate to a gaming device having a radially expanding matrix based on matches to a master symbol and methods of administering, operating, and playing the same in wagering a non-wagering applications.

### Description of Related Art

To play a conventional slot machine, a player deposits money in the form of coins, gaming tokens or digital or paper currency into a coin head, bill acceptor, or the like. The coins and gaming tokens are collected in a reservoir inside the gaming machine while the paper currency is collected in the bill acceptor inside the gaming machine. A processor validates the coins, gaming token, paper currency, or other form of currency as authentic and converts to credits. The playing credits may be shown as a monetary amount, a number of spins, or some other multiplier of the monetary value deposited. For example, a twenty-five cent gaming machine will accrue four credits for each dollar that is deposited into the gaming machine.

After accruing credits on the credit meter, the player determines how many credits he wishes to wager on the next spin of the slot reels. After setting the wager, the player spins the reels by pressing the spin button or by pulling a handle. The processor determines which portion of the reels to display on a display window on a display device. When the reels stop spinning, symbols are displayed. The processor determines if there is a win condition and if so issues credit to the player.

### SUMMARY

Embodiments of the present invention generally relate to a gaming device having a radially expanding matrix based on matches to a master symbol.

A game device comprising: a display device; an input device; a plurality of symbols; plurality of reels, each reel comprising a plurality of reel symbol positions wherein there is a symbol from the plurality of symbols in each reel symbol position; and a processor for accessing a plurality of instructions which, when executed by the processor, cause the processor to operate with the display device and the input device to: display a symbol matrix comprising a plurality of symbol matrix positions including a master symbol position; display one of the symbols in the master symbol position; generate a plurality of random numbers using a random number generator; display a portion of a plurality of first reels from the plurality of reels in the symbol matrix positions; determine if any of the symbols displayed in the symbol matrix match the first matching symbol.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiment of embodiments encompassed within the scope of the present invention, and therefore, are not to be considered limited for the present invention may admit to other equally effective embodiments, wherein:

FIG. 1A depicts a front perspective view of a gaming device in the form of a slot machine in accordance with one embodiment of the present invention.

FIG. 1B depicts a front perspective view of a gaming device in the form of a slot machine in accordance with another embodiment of the present invention.

FIG. 1C depicts a front perspective view of a gaming device in the form of a mobile device in accordance with one embodiment of the present invention.

FIG. 1D depicts a front perspective view of a gaming device in the form of a personal computer in accordance with one embodiment of the present invention.

FIG. 2A depicts a schematic block diagram of a general purpose computer system, which may be used with any of the gaming devices of FIGS. 1A-1D, in accordance with embodiments of the present invention.

FIG. 2B depicts a schematic block diagram illustrating a plurality of gaming terminals and communication with a central controller in accordance with one embodiment of the present invention.

FIG. 3A depicts a view of the reels in connection with one of the display devices, illustrating one embodiment of the present invention.

FIG. 3B depicts a front-elevation view of the display device illustrating one embodiment of the present invention in accordance with the embodiment illustrated in FIG. 3A.

FIG. 3C depicts a view of the reels in connection with one of the display devices, illustrating one embodiment of the present invention.

FIG. 3D depicts a front-elevation view of the display device illustrating one embodiment of the present invention in accordance with the embodiment illustrated in FIG. 3C.

FIG. 4 depicts a front-elevation view of one of the display devices, illustrating another embodiment of the present invention.

FIGS. 5A and 5B depict front-elevation view of one of the display devices illustrating another embodiment of the present invention.

FIG. 6 illustrates an illustration of a paytable component.

FIGS. 7A-7C depict front elevation view of one of the display devices illustrating another embodiment of the present invention.

FIGS. 8A-8C depict front elevation view of one of the display devices illustrating another embodiment of the present invention.

FIGS. 9A-9C depict front elevation view of one of the display devices illustrating another embodiment of the present invention.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following descriptions. Furthermore, the examples disclosed herein are for exemplary purposes only and other examples may be employed in lieu of, or in combination with, the examples disclosed.

Embodiments of the present invention generally relate to a gaming device having a radially expanding matrix based on matches to a master symbol and methods of administering, operating, and playing the same in wagering a non-wagering applications.

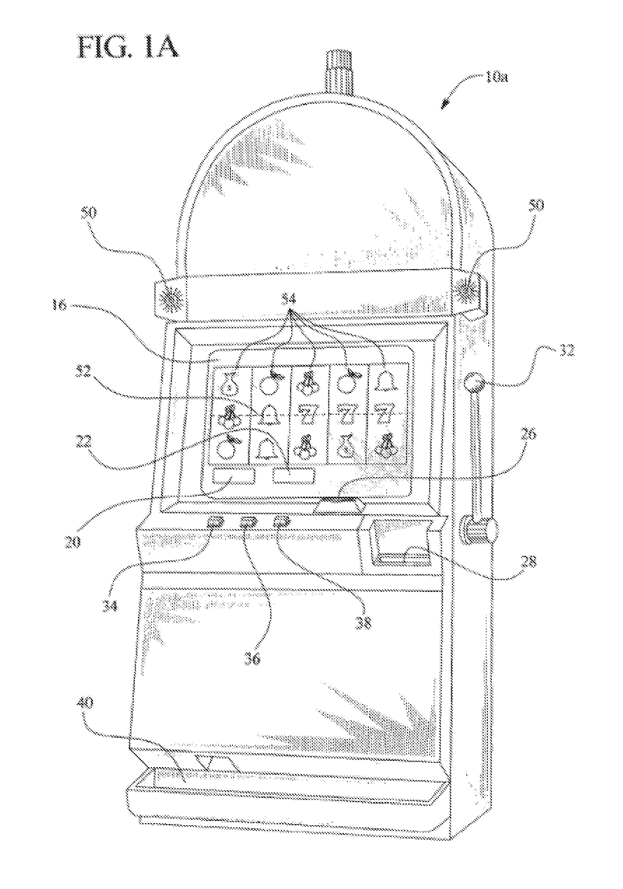

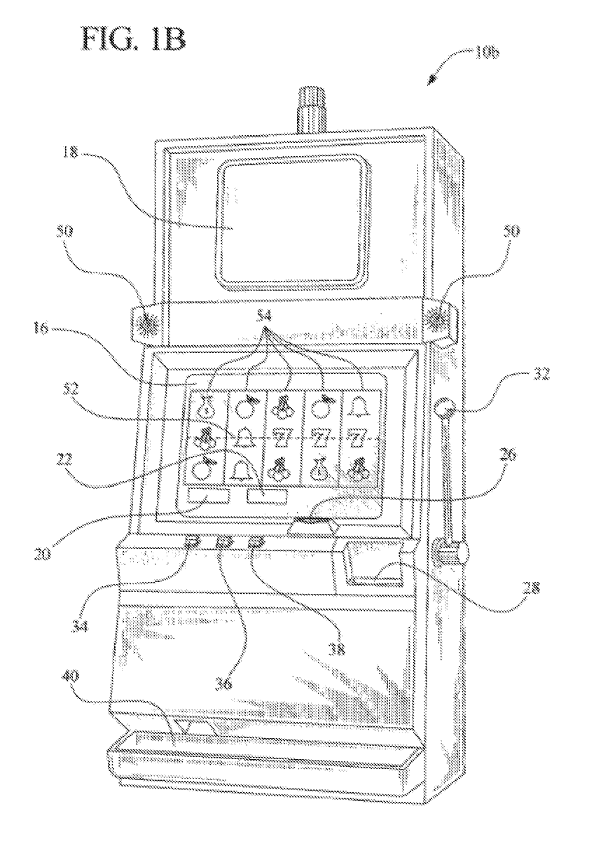

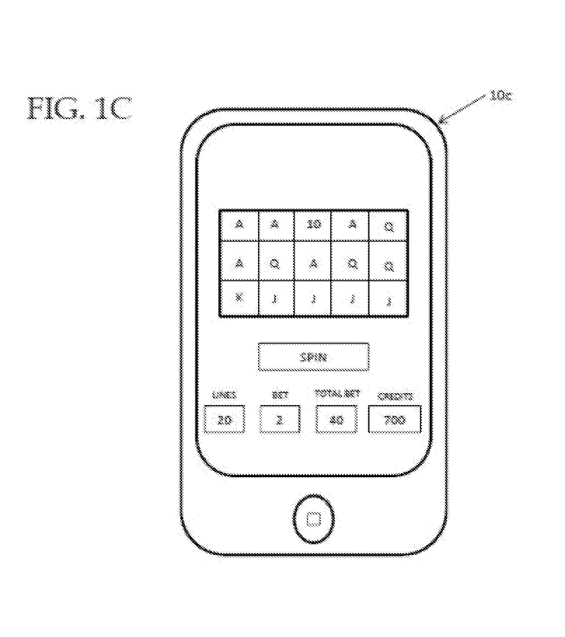

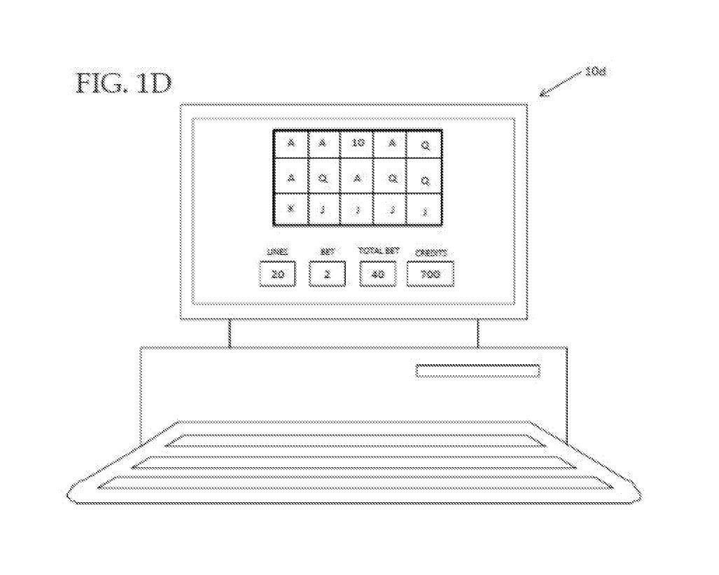

Two alternative embodiments of the gaming device of the present invention are illustrated in FIGS. 1A and 1B as gaming device 10a and gaming device 10b, respectively. Gaming device 10a and/or gaming device 10b are generally referred to herein as gaming device 10.

In one embodiment, as illustrated in FIGS. 1A and 1B, gaming device 10 has a support structure, housing or cabinet which provides support for a plurality of displays, inputs, controls, and other features of a conventional gaming machine. It is configured so that a player can operate it while standing or sitting. The gaming device may be positioned on a base or stand or can be configured as a pub-style table-top game (not shown) which a player can operate preferably while sitting. As illustrated by the different configurations shown in FIGS. 1A and 1B, the gaming device can be constructed with varying cabinet and display configurations.

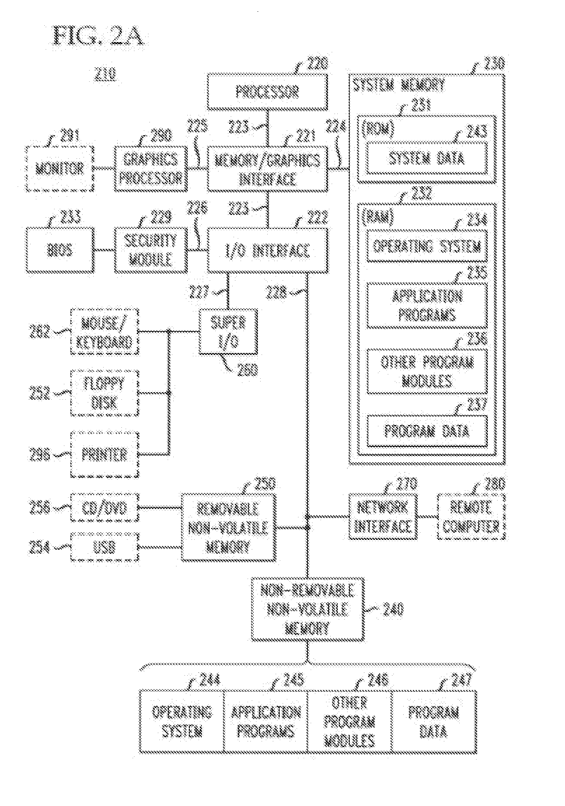

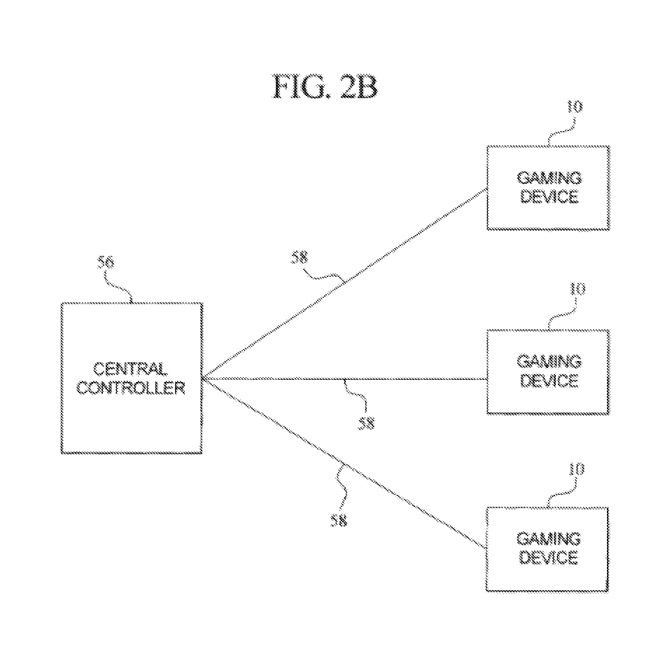

In several embodiments, the electronic gaming devices, for example, as shown in FIGS. 1A-1D, may comprise all or part of a computer system, for example, the computer system of FIG. 2. It should be appreciated, however, the computing system of FIG. 2 is merely an exemplary embodiment of an electronic device, and actual electronic devices may comprise any one or more components shown in FIG. 2A, suitable for embodiments of the present invention.

With reference to FIG. 2A, a computer system in the form of a computer 210 is shown. As understood by embodiments of the present invention, components shown in dashed outline are not part of the computer 210, but are used to illustrate the exemplary embodiment of FIG. 2A. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hyper transport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage receipt of money/credits, issuance of money/credits, and enforcement of policies, as may be required in the gaming industry. In many embodiments, such security module 229 may be coupled with a payment acceptor built into a physical machine. A payment acceptor may include a coin slot and a payment, note or bill acceptor, where the player inserts money, coins or tokens. For example, the player can place coins in the coin slot or paper money, ticket or voucher into the payment, note or bill acceptor. In other embodiments, devices such as readers or validators for credit cards, debit cards or credit slips could be used for accepting payment. In one embodiment, a player may insert an identification card into a card reader of the gaming device. In one embodiment, the identification card is a smart card having a programmed microchip or a magnetic strip coded with a player's identification, credit totals and other relevant information. In one embodiment, money may be transferred to a gaming device through electronic funds transfer. When a player funds the gaming device, the processor determines the amount of funds entered and the corresponding amount is shown on the credit or other suitable display as described above.

A super input/output chip 260 may be used to connect to a number of ‘legacy’ peripherals, such as floppy disk 252, keyboard/mouse/buttons 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2A illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2A, provide storage of computer readable instructions, data structures, program modules and other data for the computer 210. In FIG. 2A, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum; they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

Returning to FIGS. 1A-1D, in one embodiment, as discussed in more detail below, the gaming device randomly generates awards and/or other game outcomes based on probability data. That is, each award or other game outcome is associated with a probability and the gaming device generates the award or other game outcome to be provided to the player based on the associated probabilities. In this embodiment, since the gaming device generates outcomes randomly or based upon a probability calculation, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device removes the provided award or other game outcome from the predetermined set or pool. Once removed from the set or pool, the specific provided award or other game outcome cannot be provided to the player again. This type of gaming device provides players with all of the available awards or other game outcomes over the course of the play cycle and guarantees the amount of actual wins and losses.

As shown by FIGS. 1A and 1B, and supported by the elements depicted in FIG. 2A, many embodiments of the present invention comprise at least one, and often a plurality, of input devices in communication with the processor. The input devices can include any suitable device which enables the player to produce an input signal which is read by the processor, for instructing the game and/or gaming device to do something. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIGS. 1A and 1B, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash-out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips redeemable by a cashier or funding to the player's electronically recordable identification card.

In one embodiment, one input device is a touch-screen coupled with a touch-screen controller, or some other touch-sensitive display overlay to allow for player interaction with the images on the display. The touch-screen and the touch-screen controller are connected to a video controller. A player can make decisions and input signals into the gaming device by touching touch-screen at the appropriate places.

In one embodiment, the gaming device includes a sound generating device controlled by one or more sound cards which function in conjunction with the processor. In one embodiment, the sound generating device includes at least one and preferably a plurality of speakers or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a player or other sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Suitable gaming devices may incorporate any suitable wagering primary or base game. The gaming machine or device of embodiments of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation from a wager. That is, different primary wagering games, such as video poker games, video blackjack games, video Keno, video bingo or any other suitable primary or base game may be implemented into an embodiment of the present invention.

In one embodiment, a base or primary game may be a slot game with one or more pay lines 52. The pay lines may be horizontal, vertical, circular, diagonal, angled or any combination thereof. In this embodiment, the gaming device displays at least one and preferably a plurality of reels 54, for example, having three to five reels 54 in either electromechanical form with mechanical rotating reels or video form with simulated reels and movement thereof. In one embodiment, an electromechanical slot machine includes a plurality of adjacent, rotatable wheels which may be combined and operably coupled with an electronic display of any suitable type. In another embodiment, if the reels 54 are in video form, the plurality of simulated video reels 54 are displayed on one or more of the display devices as described above. Each reel 54 displays a plurality of indicia such as bells, hearts, fruits, numbers, letters, bars or other images which may generally correspond to a theme associated with the gaming device. In this embodiment, the gaming device awards prizes when the reels of the primary game stop spinning if specified types and/or configurations of indicia or symbols occur on an active pay line or otherwise occur in a winning pattern.

In one embodiment, in addition to winning credits in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, the bonus or secondary game may be any type of suitable game, either similar to or completely different from the base or primary game. In one embodiment, the gaming device includes a program which will automatically begin a bonus round when the player has achieved a triggering event or qualifying condition in the base or primary game. In one embodiment, the triggering event or qualifying condition may be a selected outcome in the primary game or a particular arrangement of one or more indicia on a display device in the primary game, such as the number seven appearing on three adjacent reels along a pay line in the primary slot game embodiment seen in FIGS. 1A and 1B. In another embodiment, the triggering event or qualifying condition may be by exceeding a certain amount of game play (number of games, number of credits, amount of time), reaching a specified number of points earned during game play or as a random award.

In one embodiment, once a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or geometric increase in the number of bonus wagering credits awarded. In one embodiment, extra bonus wagering credits may be redeemed during the bonus game to extend play of the bonus game.

In one embodiment, no separate entry fee or buy in for a bonus game need be employed. That is, a player may not purchase an entry into a bonus game; he must win or earn entry through play of the primary game and, thus, play of the primary game is encouraged. In another embodiment, qualification of the bonus or secondary game could be accomplished through a simple “buy in” by the player if, for example, the player has been unsuccessful at qualifying through other specified activities.

In one embodiment, as illustrated in FIG. 2B, one or more of the gaming devices 10 of embodiments of the present invention may be connected to each other through a data network or a remote communication link 58 with some or all of the functions of each gaming device provided at a central location such as a central server or central controller 56. More specifically, the processor of each gaming device may be designed to facilitate transmission of signals between the individual gaming device and the central server or controller.

In one embodiment, the game outcome provided to the player is determined by a central server or controller and provided to the player at the gaming device of an embodiment of the present invention. In this embodiment, each of a plurality of such gaming devices is in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to each other.

The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to some embodiments of the present invention, particularly if such communications are encrypted. Higher data transmission speeds may be useful for enhancing the sophistication and response of the display and interaction with the player.

In another embodiment, a plurality of gaming devices at one or more gaming sites may be networked to a central server in a progressive configuration, wherein a portion of each wager to initiate a base or primary game may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between the gaming device hardware and software and the host site computer.

In some embodiments, the data network may be integrated into an existing network platform, for example, a social networking site. For example, in one embodiment, the data network may comprise an application within a social networking site, e.g., Facebook, whereby players may access the data network via a connection to the social networking site. Such an integrated arrangement may be advantageous for applications of embodiments of the present invention that seek to have near immediate access to a significant potential customer base.

In further embodiments, the data network may be accessed via a downloadable application to a mobile device, such as a smartphone, a tablet, a mobile computer, or the like. As is known in the mobile device industry, such a downloadable application may be stored at a remote server, and upon request, a player may utilize a mobile device to download such downloadable application to be stored locally on the mobile device. Such downloadable application may access the data network through the mobile device's network connection, and provide the player a convenient means through which to access the data network. In alternative embodiments, the downloadable application may not require a network connection on a regular basis, and a game may be accessible locally on the mobile device. However, in such embodiments, some of the benefits of networked game play, such as competitions, updates, etc., may not be available until the mobile device reconnects to the data network.

In another embodiment, the data network is a global computer network, such as the Internet, or an intranet network, and the gaming system may be considered an online system, a mobile system, or the like. In this embodiment, the operation of the gaming device can be viewed at the gaming device with at least one web browser, or application, such that access to the data network is feasible. In this embodiment, operation of the gaming device and accumulation of credits may be accomplished with a connection to the central server or controller through a conventional phone or other data transmission line, digital signal line (DSL), T-1 line, coaxial cable, fiber optic cable, or other suitable connection. In this embodiment, players may access a game page from any location where a network connection and computer, or other gaming device 10, are available. For example, either of the gaming devices of FIGS. 1C and 1D are suitable for accessing such a data network.

Slot symbols are ideally located on multiple reels (also called columns) placed adjacent to each other. Reels can either be mechanical reels with fixed symbols located on the reels or an electronic simulation of the mechanical reels whereby the processor generates symbols on position on the electronic reels. In most embodiments, there are at least three reels in the reel sets.

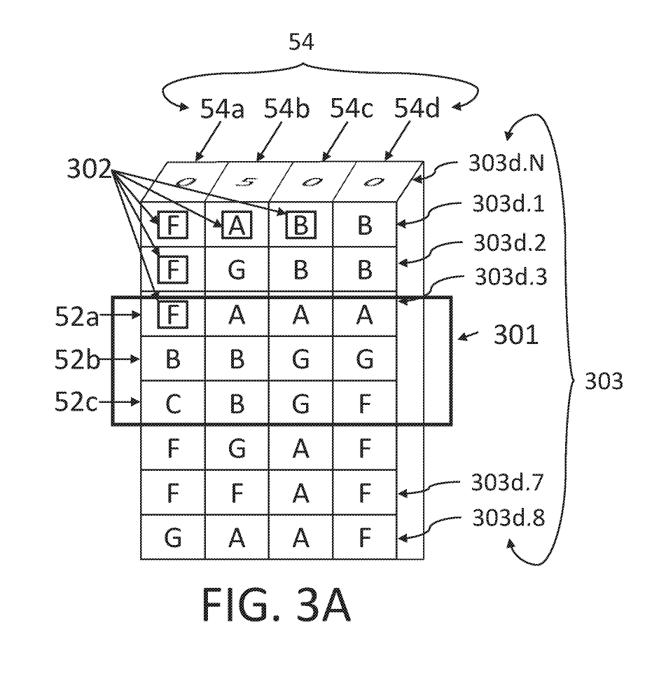

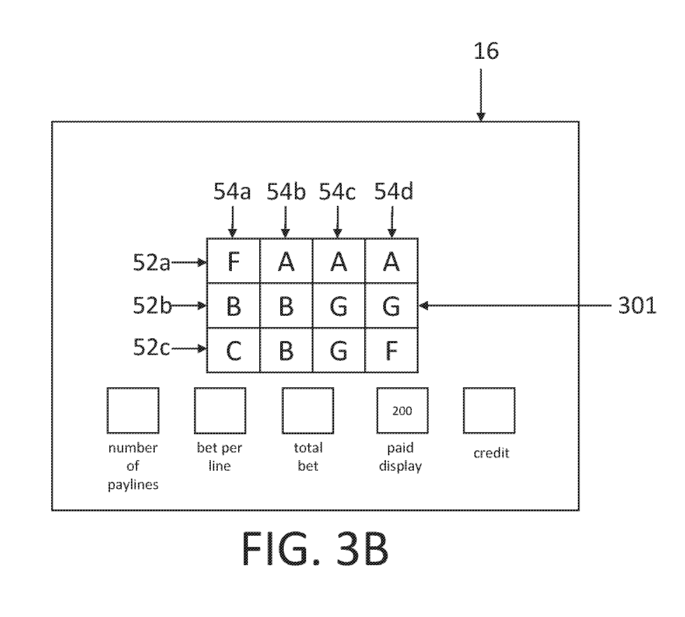

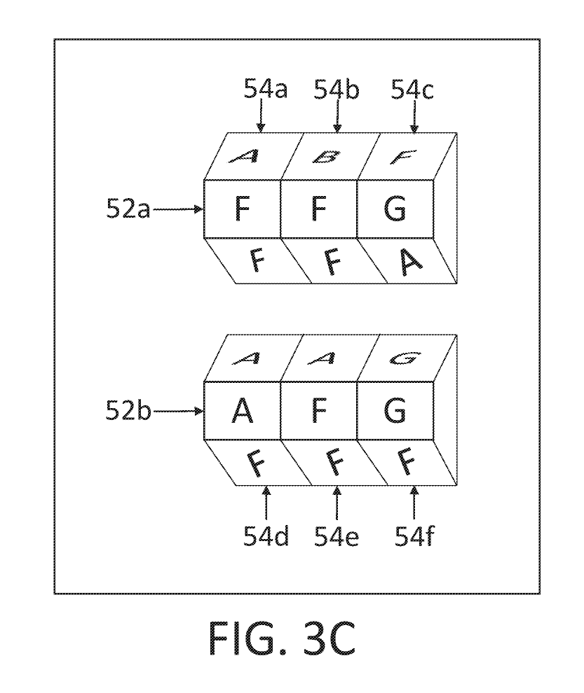

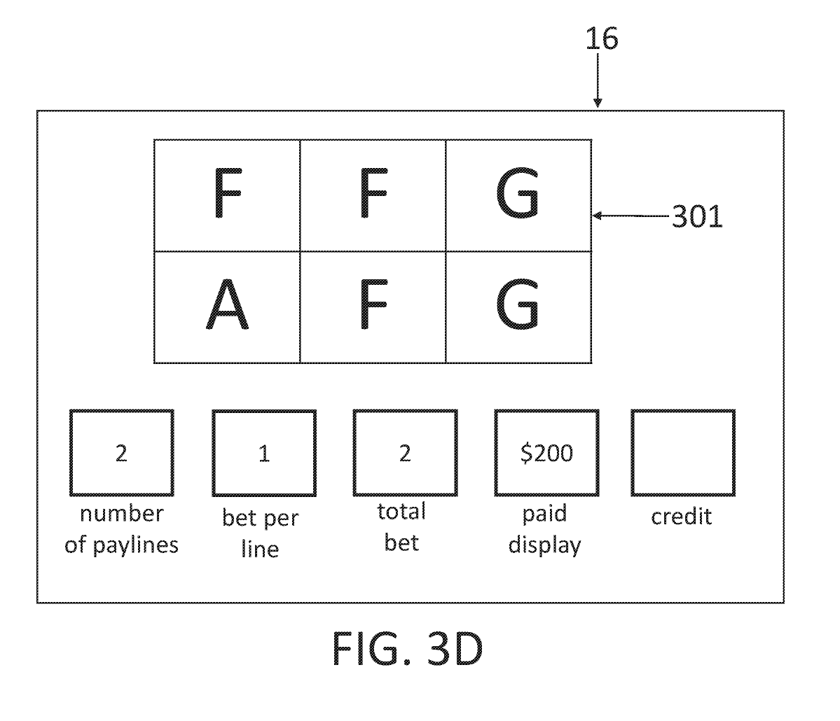

FIG. 3A illustrates a schematic view of a slot machine having four reels 54a-d and a symbol matrix 301 having three rows 52a-c. It should be appreciated that there may be any number of reels 54 and any number of displayed rows 52. Each of the reels have multiple reel positions 303a.1-303a.N, 303b.1-303b.N, 303c.1-303c.N, and 303d.1-303d.N. FIG. 3 shows reels all having the same length and number of reel positions, but it should be appreciated that the reels can have different lengths and different number of reel positions. The reels can be mechanical reels or virtual representations of mechanical reels. Additionally, each of the reel positions may ideally have a symbol 302. It should be appreciated that electronic or virtual reels can be a string or an array, list, file in a computer program, or the like. It should be appreciated that symbols can be stored on electronic reels with a numerical or placeholder representation with a lookup table to display symbols on the virtual display.

The reel strips may be stored in the device's memory as an array of symbol numbers or similar identifiers such as ReelStrips[NUMREELS][MAXNUMSTOPS], where NUMREELS is constant, typically five or six, representing the number of reel strips, and MAXNUMSTOPS is the maximum of the number of positions per reel strip. Typically the reel strips have different lengths recorded in an array NumStops[NUMREELS]. Thus Reel Strips [i][j] stores the number of symbols in position j on reel number I, for every i<NUMREELS and j<NumStops[i].

The visual display 16 includes a visible display area or symbol matrix 301 whereby a player can see a portion of the reels. FIG. 3B illustrates a final visible display area including symbol matrix 301. A typical example is a symbol matrix that displays three to five columns of three adjacent reels. In this typical example, the resulting symbol matrix is a rectangular display of symbols (nine symbols when three columns of three reels are visible and fifteen symbols when five columns of three reels are visible). It should be appreciated that the symbol matrix need not be rectangular or show the same number of symbols from each reel. For example, the visual display may display one row of the first reel, two rows of the second reel, and one column from the third reel. In this example, four symbol positions would be visible. In some embodiments, only one position on each reel is visible to a player.

In some embodiments multiple reels are vertically aligned appear to be one column to the player (“independent reels”). The “independent reels” variant is depicted in FIGS. 3C and 3D. Reels 54a, 54c, and 54c are horizontally adjacent and reels 54d, 54e, and 54f are horizontally adjacent and vertically below reels 54a, 54b, and 54c. As can be seen in FIG. 3C, each of the reels 54a-f has multiple reel symbol positions, but only one symbol from each of the reels 54a-f are visible. FIG. 3D depicts the display to the player on the display device. The single symbol from each of the reels 54a-f appear in a symbol matrix that has the same appearance as if there were three reels each with two visible symbols.

During the playing of a game, the symbols in the reel positions, can be provided in a visual pattern of images that simulates the symbols as scrolling through the window at a speed which, at least for part of the game play period, is sufficiently slow that they are legible to the player.

A random number generator determines stop positions for the reels. The stops positions then correspond with a reel position to be displayed. According to rules of a particular game, a specified number of symbols above or below the reel position corresponding to the stop position.

A random (or pseudorandom) number generator may be used to determine stop positions for the reels. The processor can use any known random number generator function known in the art such as those using the linear congruential generator which uses the recursive relation: Xₙ₋₁=(aXₙ+c) mod in where X is the sequence of pseudorandom values and m is the modulous, a is the multiplier, c is the increment, and X₀ is the seed value. It should be appreciated that other random or pseudo random number generators can be used including those that are built-in functions in java, c, c++, and the like.

In some embodiments, for each reel, the random number generator will return a number equal to or less than the number of symbols in that reel—a “stop position” for each reel. This number determines the final symbols to display in the symbol matrix. In some such embodiments, the number will correspond to a symbol position on the reels. The corresponding symbol position on the reels would then be the top symbol from a reel displayed in the symbol matrix. The game rules would determine how many symbols from that reel to display. This process is repeated for each reel. It should be appreciated that the random number generated can determine which symbol is in the bottom position, middle position, or the like. It should further be appreciated that often the reels will be stored in arrays beginning in zero and that a number generated may appear to be off by a set number from the randomly generated number.

In some embodiments, the reels are physically or virtually weighted making some reel symbol positions more likely than others to appear in the symbol matrix at the end of the spin.

As an example, consider a slot machine with 3 reel strips having 5, 6, and 7 positions respectively. The array ReelStrips would look like Array 1:

| | |
|---|---|
| 0 | 100 |
| 0 | 103 |
| 0 | 100 |
| 0 | 101 |
| 0 | 102 |
| 1 | 102 |
| 1 | 101 |
| 1 | 103 |
| 1 | 100 |
| 1 | 101 |
| 1 | 102 |
| 2 | 100 |
| 2 | 101 |
| 2 | 102 |
| 2 | 103 |
| 2 | 101 |
| 2 | 101 |
| 2 | 100 |

Where 0 is the first reel strip, 1 is the second reel strip, 2 is the third reel strip, and 100 represents a certain symbol, for example a bar, 101 represents another symbol, for example a cherry, 102 represents a “7”, 103 represents a bell, and so on. Thus, ReelStrips [1] [2] would represent a cherry because a cherry is represented by the number 101, and 101 is the number found in the array in the position of the second slot of Reel 1. When a play is initiated, a stop is selected at random for each reel. Then a virtual spinning reel display is presented to the player. At the end of the play, the spinning ceases with each reel displaying its previously selected stop.

It should be appreciated that in some embodiments, a temporary final window is generated based on the final outcome and a visual display of spinning reels is shown before displaying the final result window.

Within the symbol matrix, positions on the slot reels may be referred to according to column, from left to right, and row from top to bottom. For example, symbol position 1/2 if located in column 1 (left-most column) and row 2 (second row from the top). In some embodiments, the visible display area may be a non-rectangular shape. For example, the visible display may display one column of the first reel, two columns of the second reel, and one column of the third reel. In this example, four symbol positions would be visible. In some embodiments, only one position on each reel is visible to a player. In some embodiments, multiple reels are vertically aligned and appear to be one column to the player. In some embodiments, only one symbol from each reel is visible (“independent reels”).

It should be appreciated that paylines can be any combination of matrix symbol positions. While the depicted paylines are horizontal lines through the rows, any path through the R×N symbol ma tric consisting of one symbol for each column may be considered a pay line and customarily some subset of each payline is designated in the context of a particular game.

Players collect credits for predetermined winning symbol combinations that appear in specific positions (paylines) on the slot reels. Winning combinations typically require that three or more of the same symbols appear adjacent to each other starting from the leftmost position of a pay line (“line pays”). For example, a player may collect a line pay if three banana symbols appeared in symbol matrix positions 1/1, 2/1, 3/1 on a pay line that includes symbol positions 1/1, 2/1, 3/1, 4/1, and 5/1.

A player may wager on the occurrence of a winning combination on a single pay line or on the occurrence of a winning combination on multiple pay lines. Winning combinations may also occur when three or more of the same symbols appear adjacent to each other starting from the rightmost position on a payline. Game rules may specify that some symbols may form winning combinations if there are two or more of the same symbol (“majors”) while other symbols may only form winning combinations if there are three or more of the same symbol.

Winning combinations may occur if three or more symbols appear on a payline regardless of whether they are adjacent or regardless of whether the first occurrence of that symbol is in the leftmost or rightmost column. In some instances, there are wild symbols or substitute symbols that can be matched with other symbols. Players may also collect credits for predetermined winning combinations that appear anywhere on a payline (“line scatter pays”) or anywhere on the slot reels (“reel scatter pays”). For example, a player may collect a line scatter pay if three banana symbols appeared in symbol positions 1/1, 2/1, and 5/1 on a payline using matrix symbol positions 1/1, 2/1, 3/1, 4/1, and 5/1; and collect a reel scatter pay if three banana symbols appear anywhere on the visible slot reels.

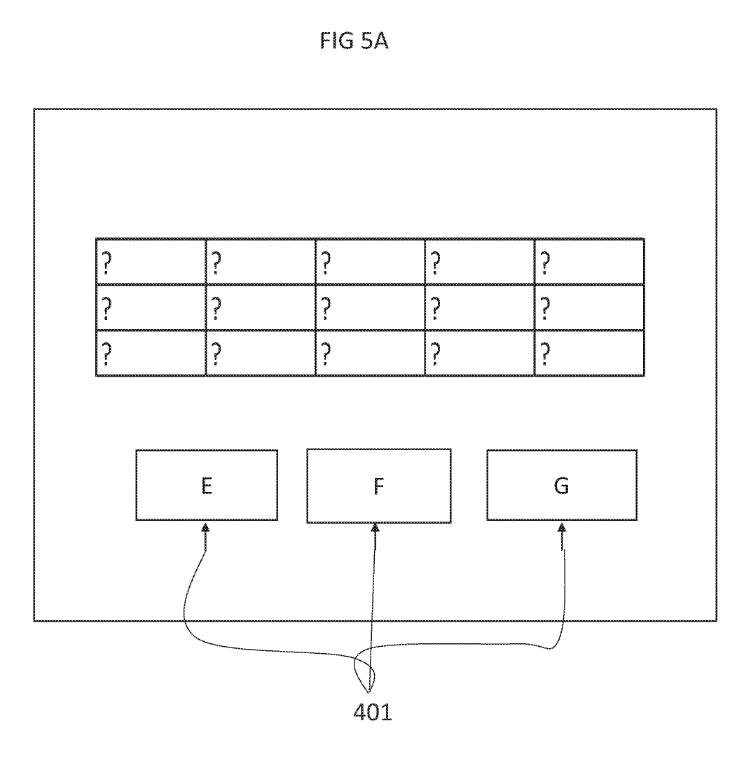

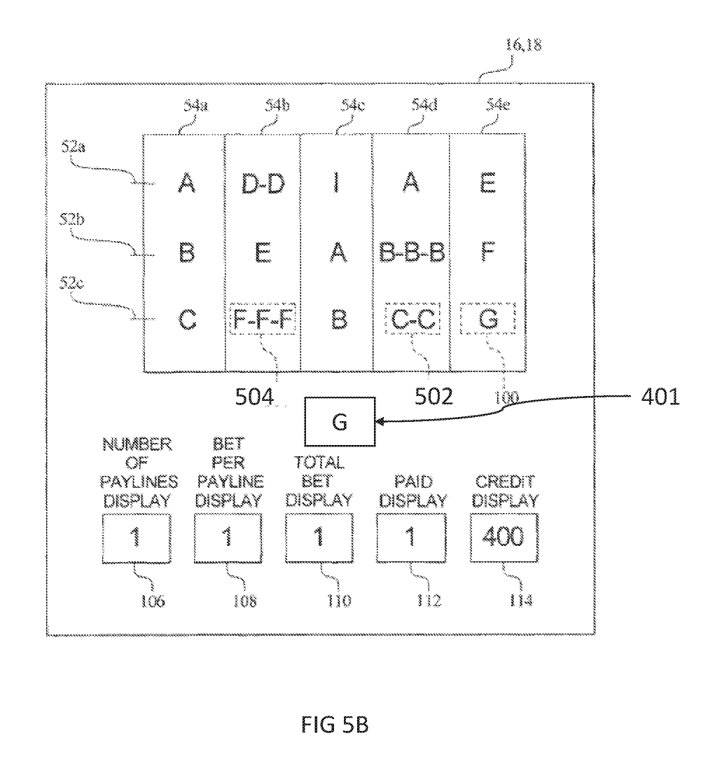

The symbols on the reels can include dual replicated symbols 502 which act as two symbols in a single symbol positions and triple replicated symbols 504 depicted in FIG. 5B which act as three symbols in a single symbol position as is fully disclosed in U.S. Pat. No. 7,402,102.

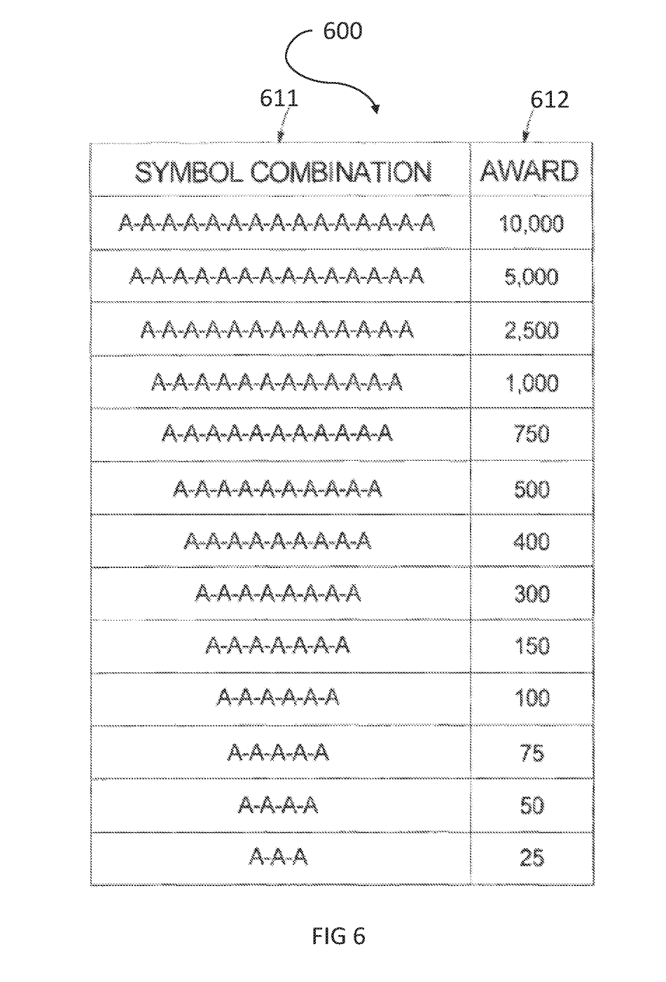

Credits are awarded to the player for each winning symbol combination based on a predetermined schedule. For line pays and line scatter pays, the number of credits wagered on the winning pay line multiplies the number of credits indicated by the pay table 610 depicted in FIG. 6 having symbol combination column 611 and corresponding awards 612. For example, a player may wager one credit each on three pay lines, spin the reels, and then collect the amount indicated on the pay table for a line pay or line scatter pay appearing on any of the five played pay lines. Alternatively, if a player wagered more than one credit on a line with a win, the machine would multiply the award indicated by the paytable with the wager for the line. For reel scatter pays, the total number of credits wagered multiplies the award indicated by the pay table. For example, a player may wager three total credits, spin the reels, and collect three times the amount indicated on the pay table for a reel scatter pay appearing anywhere in the symbol matrix. As disclosed in U.S. Pat. No. 9,251,667, some winning combinations do not rely on paytable 610.

Following any type of pay (e.g., line pays, line scatter pays, or reel scatter pays), credits won are added to the player's credit balance shown on the credit meter. As long as the player has credits on the credit meter, the slot machine is ready to accept a spin command from a player. Following any spin, the player may collect the credit balance by pressing a Cash Out button. Credits may be paid out in many different ways. Credits can be paid out as cash, cash alternatives, credits to play the game, or an upgrade on gameplay.

In some embodiments, the machine includes a set of meters or displays used to display the relative information for the game, including the number of credits, number of pay lines, amount bet per line, total bet, and the amount paid to the player in a spin of the reels. Any number of meters may be added to further facilitate control of the games. In another embodiment, the number of credits in the credit pool is displayed by a credit meter or credit display. The pool of credits increases and decreases according to the player's wins or losses in a game and may be supplemented, if necessary, by the player when the player deposits additional coins, tokens or paper currency into the gaming device. In some embodiments, the number of pay lines upon which the player wagered in a game is displayed on a Number of Pay Lines meter or display. The pay lines are activated in a predetermined order, as follows: the first wager is applied to a first pay line; the second wager is applied to a second pay line; and the third wager is applied to a third pay line. However, the games may have fewer or greater than three pay lines and activate the paylines in any suitable order.

In a further embodiment, the number of credits wagered on each pay line is displayed on a Bet Per Line display. In this embodiment, the same amount is wagered on each of the pay lines. Alternatively, in other embodiments the player could wager different amounts on each pay line in a game. In one embodiment, the total number of credits bet on all of the pay lines may be displayed by a Total Bet display. The total bet is calculated by multiplying the number of pay lines by the bet per line. In addition, the number of credits awarded for any winning symbol combinations may be displayed by a Paid display.

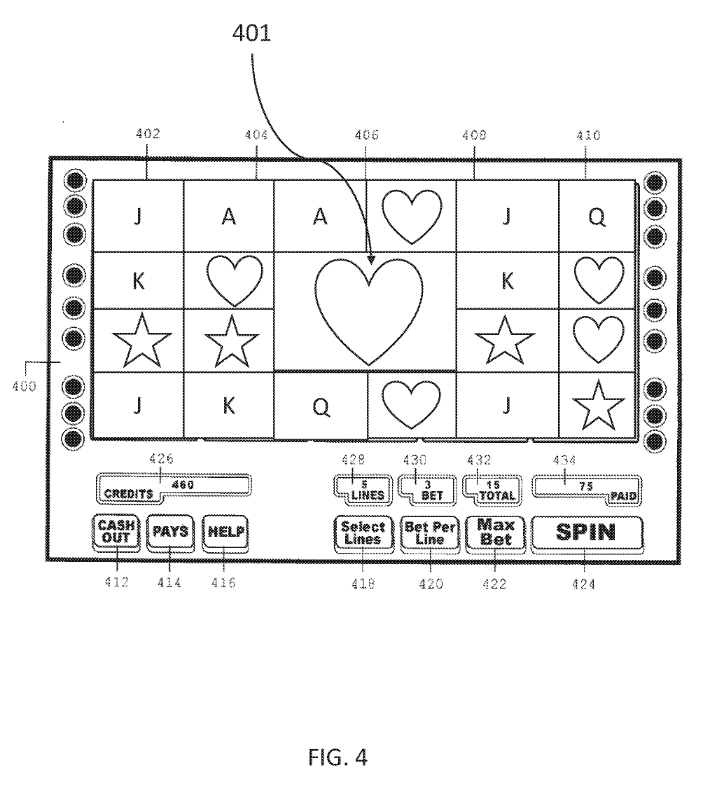

FIG. 4 shows an exemplary video display 400 including a 5-column by 3-row symbol matrix, as shown on the slot reels 402-410. The first column 402, second column 404, third column 406, fourth column 408 and fifth column 410 all hold three symbols. Alternatively, the game could utilize any number of columns and reels, such as a 3-column by 3-row symbol matrix.

FIG. 4 also shows an exemplary set of control buttons 412-424 used by the player to control the functions of the slot game. These buttons may include Cash Out 412, Pay Table 414, Help 416, Select Pay Lines 418, Bet Per Line 420, Max Bet 422 and Spin 424. Any or all of these control buttons may be displayed on the video display 400 and/or buttons hard wired to the gaming device. If necessary, any number of buttons may be added or removed to further facilitate control of the games

FIG. 4 additionally shows a set of exemplary meters 426-434 used to display the salient information for the game, including Credits 426, Number of Pay Lines 428 Amount Bet Per Line 430, Total Bet 432, and Paid 434. The Credits meter 426 displays the total number credits remaining in the credit pool. The Number of Pay Lines meter 428 is associated with the Select Pay Lines button and displays the current number of Pay Lines Selected. The Amount Bet Per Line 430 meter is associated with the Bet Per Line button 420 and displays the number of credits wagered per pay line. The Total Bet 432 meter displays the cumulative value of the Number of Pay Lines 428 and Amount Bet Per Line 430. The Paid meter 434 displays the number of credits won on the last spin.

FIG. 4 also shows an exemplary number of credits in the credit pool, as displayed on the Credits meter 426. The pool of credits increases and decreases according to the player's wins or losses and may be supplemented, if necessary, by the player by additional deposits of coins, tokens or paper currency.

FIG. 4 shows an exemplary number of pay lines upon which the player wagered, as displayed on the Number of Pay Lines meter 428. An exemplary number of credits wagered on each pay line is provided, as displayed on the Bet Per Line meter 430. Usually the same amount is wagered on each pay line. Alternatively, however, the player could be allowed to make wagers of different amounts on each pay line. The total amount wagered is determined by summing the amounts wagered on each pay line. FIG. 3 also shows the total number of credits bet on all of the pay lines, as displayed on the Total Bet meter 432. The total bet is calculated by multiplying Number of Pay Lines 428 by Bet Per Line 430.

In a base example game, a player is standing in front of a nickel-denomination version of an embodiment of the present invention. The player sees the slot game on the video display 400, illustrated for example in FIG. 3. The slot game uses a 5-column by 3-row symbol matrix, as shown on the slot reels 402-410. For this example, video display 400 is populated with symbols and/or information described below which replaces the symbols and/or information currently displayed in FIG. 4.

Below the video display 400, the button panel holds seven buttons: Cash Out 412, Pay Table 414, Help 416, Select Pay Lines 418, Bet Per Line 420, Bet Max 422, and Spin 424. In addition, there are also five meters on the video display 400 below the game: Credits 426, Number of Pay Lines 428, Amount Bet Per Line 430, Total Bet 432 and Paid 434.

The player presses the “Pay Table” button 414 to vide the pays for winning combinations. After viewing the pay table, the player deposits currency in the form of $20 into the bill receptor and the credit meter 426 counts up from 0 to 400 as the example denomination for the game is five cents per credit. The player than selects the wager for the game using the various input buttons. The player sets the Number of Pay Lines meters to 5 to indicate that the player wants to wager on five paylines. An exemplary set of paylines used in this example is illustrated in FIG. 10. As the player presses the Select Pay Lines button 418, the video display 400 shows the locations of each selected pay line on the slot reels 402-410. For example, the first pay line 502 starts in the middle row of slot reel 402 and proceeds in the straight line through the middle position of slot reels 404-410. It should be appreciated that in some embodiments, the number of paylines can be fixed by the processor.

The game's Amount Bet Per Line meter 430 reads 1. The player presses the Bet Per Line button 420 two times and the Amount Bet Per Line meter 430 counts up from 1 to 3; The Total Bet meter 432 started at 1, but after player adjustments it now reads 15; and The Paid meter 434 reads 0. It should be appreciated that a machine may set the amount per bet.

In some embodiments a player also has the option to select the areas to bet on such as columns or specific symbols in the symbol matrix as described in U.S. Pat. No. 7,686,686, whether to activate an additional feature, or on the occurrence of a particular symbol or type of symbol appearing in the symbol matrix

After setting the wager, the player presses the spin button 424. The credits meter 426 counts down based on the amount wagered. The slot reels 402-410 spin, stop, and display a variety of symbols. When the reels are activated, electronic reels appear to be spinning to the player. In some embodiments, the symbols from the reels appear to scroll through the symbol matrix positions. In some embodiments, the symbols appear to scroll vertically up or down the symbol positions in a column. In some embodiments, the symbols appear to be scrolling horizontally left or right through the symbol positions in the rows in the symbol matrix. In some embodiments, spinning reels is simulated by the processor displaying the symbols one by one in the matrix based on what symbol should appear next.

A random number generator is called by the processor to generate a random number for each of the reels. The processor uses the number for each reel to determine a stop position. The symbol on the reel symbol position corresponding with the stop position is displayed in the symbol matrix on the display device. Based on the game's programmed instructions, a specified number of symbols before and/or after the reel symbol position corresponding to the random number generated is then displayed in the symbol matrix position on the display device. It should be appreciated that in some embodiments as further detailed in U.S. Pat. No. 9,022,852, one stop position will be determined for more than one reel.

In exemplary embodiments, there is a master symbol 401. When a master symbol 401 is selected, awards are issued based on symbols matching the master symbol 401. It should be appreciated that awards can increase based on the number of symbols that match the master symbol.

In some embodiments, the processor randomly selects the master symbol using the same method of selecting other symbols in the symbol matrix positions. Namely, the processor generates a random number which corresponds with a position on a master symbol reel. It should be appreciated that like with the traditional symbols, the master symbol reel can be weighted such that some master symbols are more likely to be selected than others. It should be appreciated that in some other embodiments, a player, rather than the processor, may select a master symbol. In these embodiments, a player may select a symbol from a choice of symbols or a choice of hidden symbols. Alternatively, a player may select a symbol matrix position to be the master symbol position and the symbol that is in the master symbol position at the end of the spin becomes the master symbol for the spin.

Although FIG. 4 depicts the master symbol 401 as being an oversized symbol in the middle of the symbol matrix, the symbol can be visually displayed to a player in any location on the display and can be any size. It should be appreciated that the master symbol 401 can be fixed on traditional reels like the oversized symbol in U.S. Pat. No. 8,734,223. If a master symbol is visible at the end of a spin, then awards are issued based on the number of symbols that match the master symbol.

In some embodiments, a player selects the master symbol. FIG. 5A shows a portion of blank reels along with three choices of master symbol 401. Depicted the player can select symbol “E,” “F,” or “G.” Turning to FIG. 5B, the player has selected symbol “G” as the master symbol and is rewarded for any “G” symbols that appear in the symbol matrix at the end of the spin.

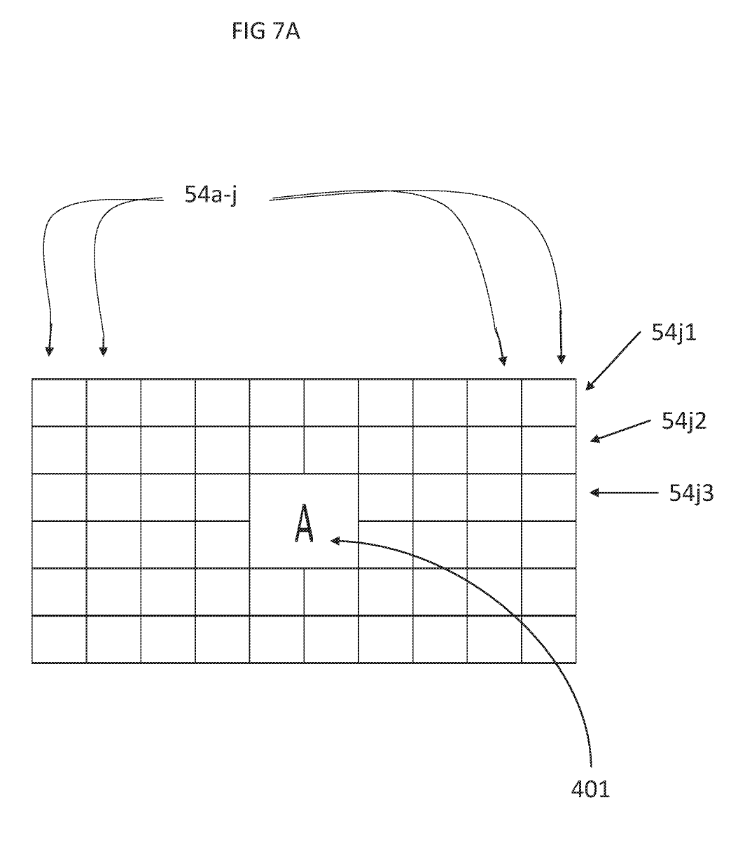

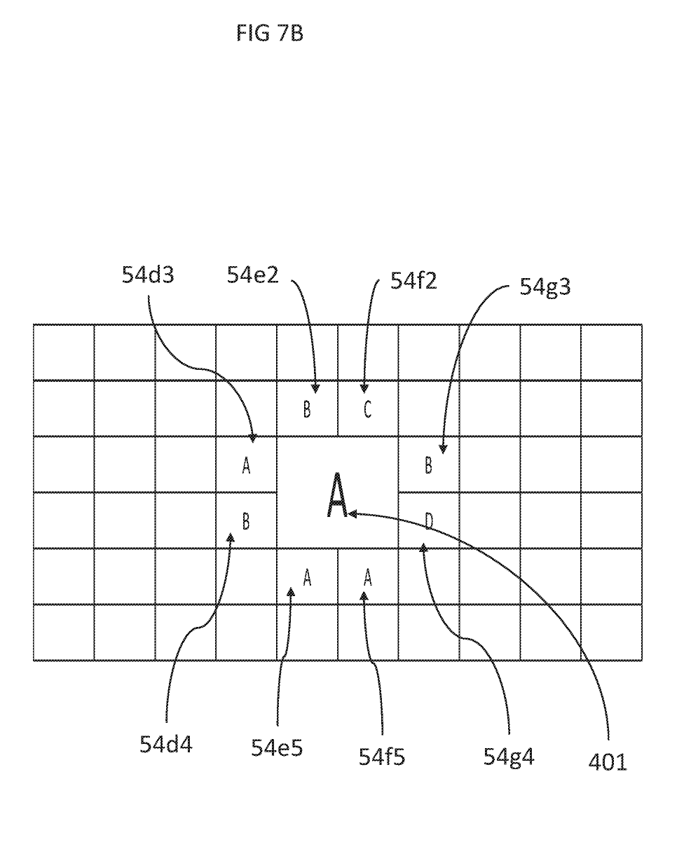

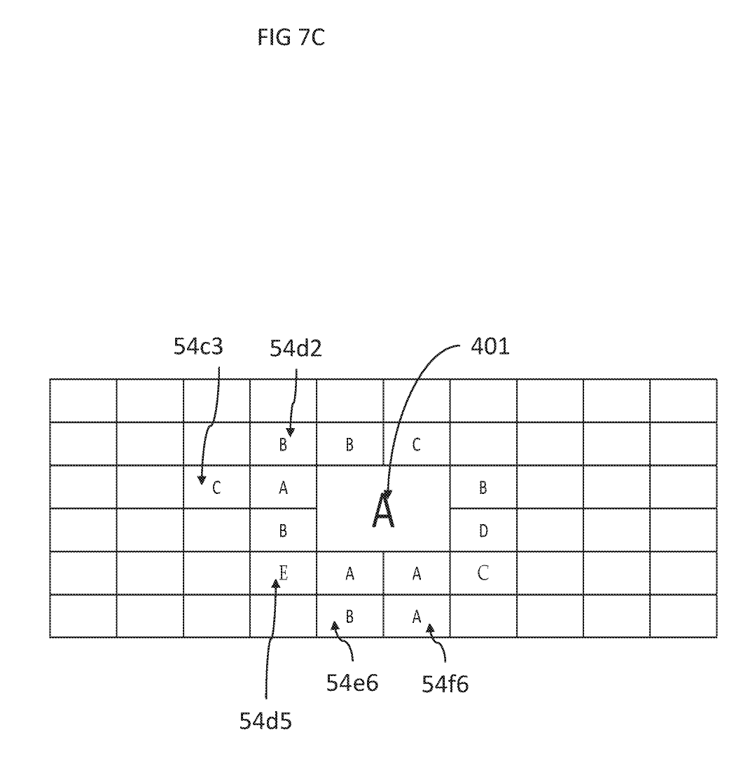

In exemplary embodiments, the active symbol matrix expands based on matches to the master symbol. In these embodiments, the independent reels 54 are spun but not displayed on a display output and symbols in the symbol matrix are revealed to a player based on matches. FIG. 7A shows multiple reels 54a1-j6 where there is only one symbol position from each reel forming a symbol matrix. In FIG. 7A, only the master symbol 401 is visible in the symbol matrix to the player. Reel positions surrounding the master symbol 401 are ones that are vertically or horizontally adjacent to the master symbol. Adjacent symbol positions are spun revealing symbols in the single visible reel position on reels 54e2, 54f2, 54d3, 54g3, 54d4, 54e5, 54f5, and 54g4 in FIG. 7B. As the master symbol is an “A”, there are three matches in the symbols surrounding the master symbol. Symbols adjacent to the matched master symbol are then revealed as can be seen in FIG. 7C. The revealed symbols expand and are revealed as long as matches to the master symbol are made.

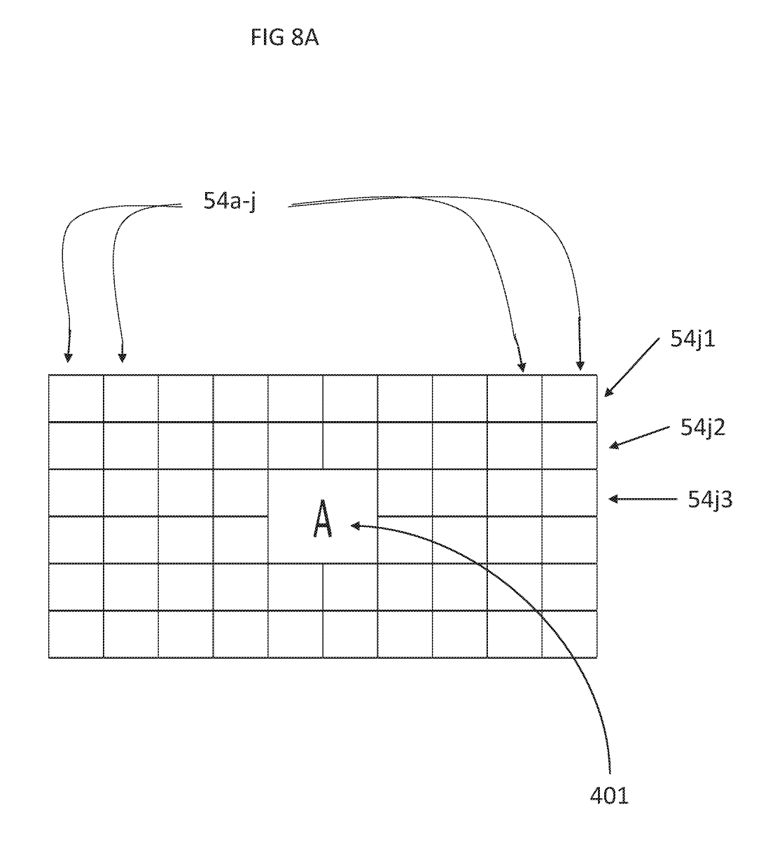

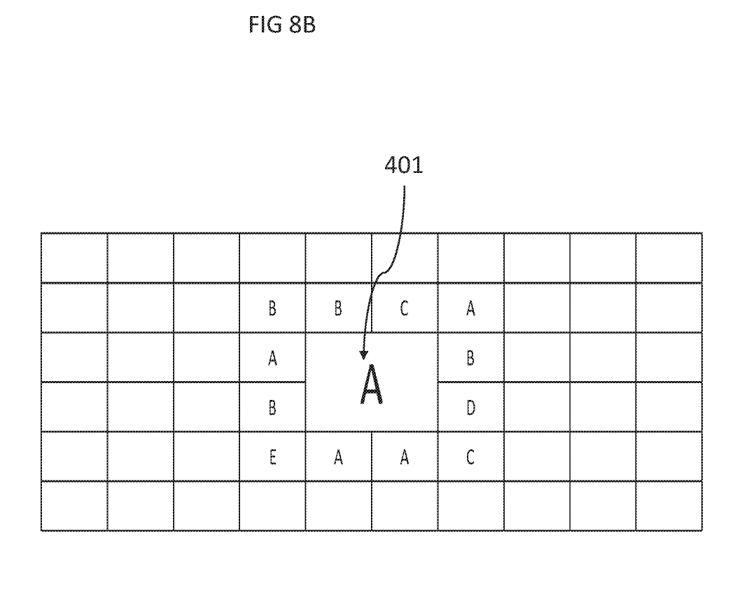

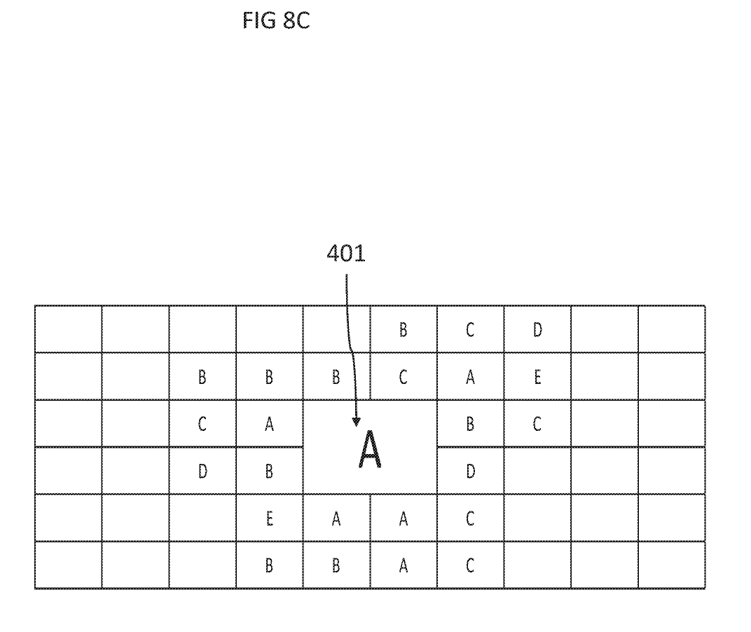

As shown in FIGS. 8A-C, in some embodiments, the surrounding symbols that are revealed after a match to the master symbol 401 include horizontally and vertically adjacent symbol positions as well as those that are diagonally adjacent. In FIG. 8A, only the master symbol 401 is visible in the symbol matrix to the player. Symbol matrix positions surrounding the master symbol are revealed in FIG. 8B. Because there are three matches, matrix symbol positions surrounding those matches are revealed in FIG. 8C.

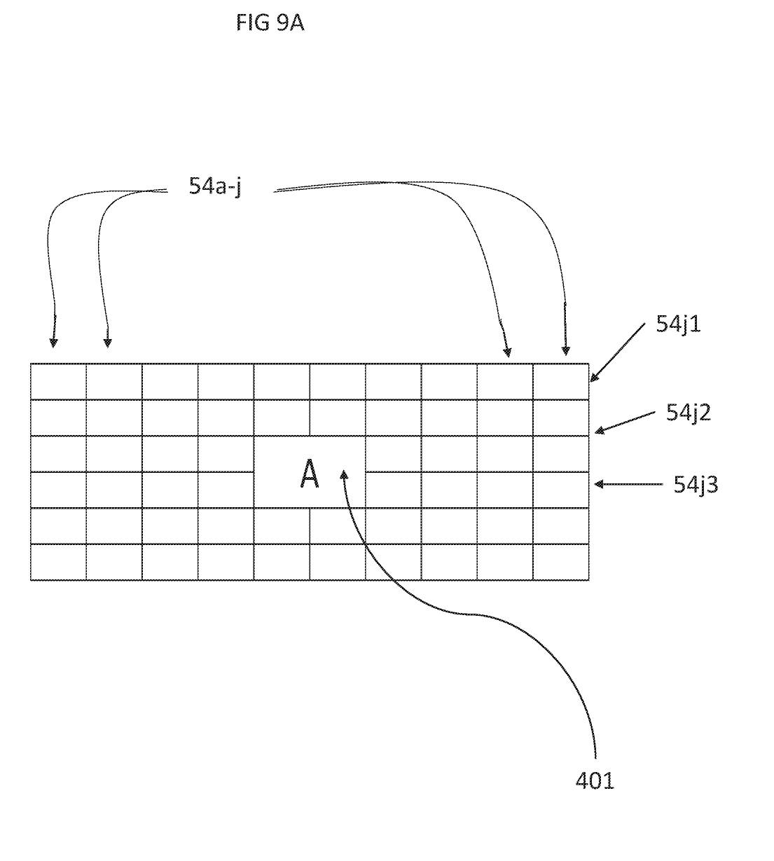

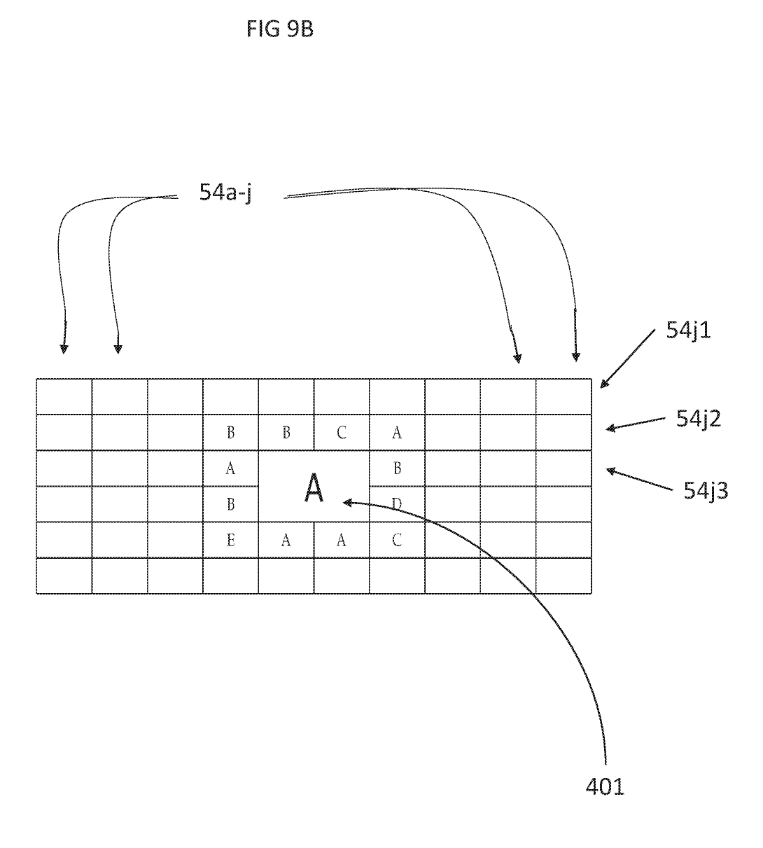

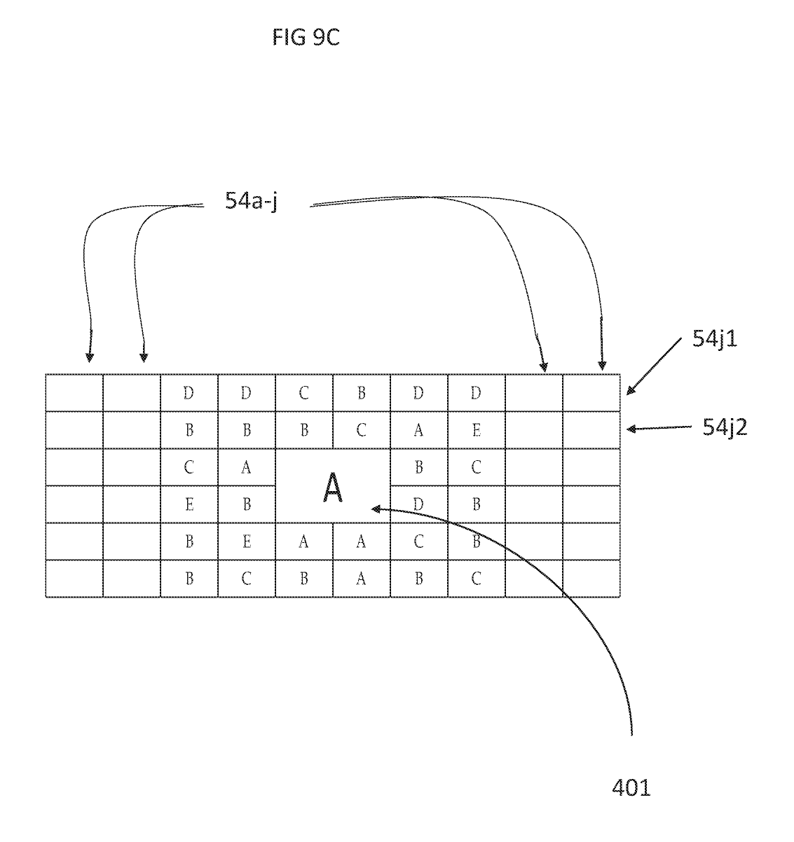

As shown in FIGS. 9A-C, in some embodiments, the symbol matrix radially expands if there is at least one match and continues to expand so long as there is at least one match to the master symbol. In FIG. 9A, only the master symbol 401 is visible in the symbol matrix. All symbol matrix positions encircling the master symbol 401 are revealed in FIG. 9B. Because there is at least one match, a further expansion of the symbol matrix is revealed in FIG. 9C.

While this disclosure includes a few specific embodiments of symbol matrix expansion rules, it should be appreciated that any rule for symbol matrix expansion should be considered.

It should be appreciated that in some embodiments, the symbols in the final symbol matrix are not set at the same time. Instead, once there is a first match, additional symbols are revealed by spinning the adjacent reels. That is, the random stop positions for each of the reels can be generated after a match to the master symbol is revealed.

Alternatively, the master symbol 401 can be an overlay over traditional reels 54a-j. In this iteration, the master symbol can appear anywhere in the matrix and surrounding symbols are then revealed to determine if there are matches to the master symbol.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. For example, an element disclosed by one embodiment of the present invention may be included in any other disclosed embodiment, where suitable. All such modifications and variations are intended to be included herein within the scope of this disclosure and the present invention.

1. A game device comprising:
a display device;
an input device;
a plurality of symbols;
a plurality of reels, each reel comprising a plurality of reel symbol positions wherein there is a symbol from the plurality of symbols in each reel symbol position;
and a processor for accessing a plurality of instructions which, when executed by the processor, cause the processor to operate with the display device and the input device to:
display a symbol matrix comprising a plurality of symbol matrix positions including a master symbol position;
display one of the symbols in the master symbol position;
generate a plurality of random numbers using a random number generator;
display a portion of a plurality of first reels from the plurality of reels in the symbol matrix positions;
determine if any of the symbols displayed in the symbol matrix match the first matching symbol.
In response to at least one symbol match to the first matching symbol, issue an award to the player.

2. The device of claim 1 wherein a plurality of second reels are revealed in the symbol matrix if a symbol matches the symbol in the master symbol position.

3. The device of claim 2 the second reels are based on proximity to the symbol matching the symbol in the master symbol position.

4. The device of claim 3 wherein the second reels are horizontal to and vertical to the symbol matching the symbol in the master symbol position.

5. The device of claim 3 wherein the second reels are horizontal, vertical, and diagonal to the symbol matching the symbol in the master symbol position.

6. The device of claim 2 wherein the second reels are based on proximity to the displayed first reels.

7. The device of claim 2 wherein a plurality of third reels are revealed in the symbol matrix if a symbol in the second reels matches the master symbol.
